(19) United States
(12) Patent Application Publication
(10) Pub. No.: US 2010/0024614 A1
(43) Pub. Date: Feb. 4, 2010

(54) METHOD FOR CUTTING OR PUNCHING CERAMIC-CONTAINING COMPOSITE MATERIALS

(75) Inventors: Friedemann REX, Marl (DE); Matthias Pascaly, Muenster (DE); Martin Trocha, Essen (DE); Christian Hying, Rhede (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/507,108

(22) Filed: Jul. 22, 2009

(30) Foreign Application Priority Data
Jul. 31, 2008 (DE) 102008040896.4

(51) Int. Cl. B26D 1/00; B28D 1/00

(52) U.S. Cl. 83/13; 125/1

(57) ABSTRACT

A method for cutting and/or punching material in which abrasive particles are present within and/or on the surface of a substrate is provided. The material cut or punched is useful as a ceramic separator for electrochemical applications including capacitors, supercapacitors, batteries, lithium ion batteries and lithium metal batteries.

### CROSS REFERENCE TO RELATED APPLICATIONS

This application claims priority to German Application No. 102008040896.4, filed Jul. 31, 2008, the disclosure of which is incorporated herein by reference in its entirety.

### BACKGROUND OF THE INVENTION

1. Field of the Invention

The invention is directed to a method for cutting and/or punching abrasive material, i.e. material in which abrasive particles are present within and/or on the surface of a substrate. The invention relates in particular to a method for cutting and/or punching ceramic separators or separators containing ceramic or oxidic constituents, which may be used, for example, in lithium ion batteries.

2. Discussion of the Background

Separators for lithium ion batteries, may consist, for example, of a substrate substance coated with ceramic constituents, containing ceramic constituents or a combination of thereof. The ceramic constituents of such ceramic separators may contain alumina (Al₂O₃), silica (SiO₂) and further metal oxides, such as, for example, BaTiO₃, ZrO₂ or TiO₂. The substrate substances may be polymers, such as polyolefins, polyesters, polyimides. The ceramic constituents may be introduced to the polymer such that the polymer serves as a matrix and the oxide as filler. Methods of applying the ceramic constituents to a porous polymer substrate may include application by impregnation, imprinting or soaking.

Ceramic or semi ceramic (hybrid) separators or ceramic membranes which maybe used as separators are described, for example, in WO 99/15262. This publication also describes the production of separators or membranes which are suitable as separators. Preferably, however, electrically conductive substrates, such as, metal fabric, are not used as porous substrates for the separators according to this invention, because in separators having such electrically conductive substrates, internal short circuits may occur if the ceramic coating of the substrate is not complete. The separators of this invention preferably have substrates comprising materials which are not electrically conductive.

Hybrid separators which comprise ceramics and polymers have been described. DE 102 08 277 provides separators based on polymeric substrate materials, for example, polymer nonwovens, which have a porous, electrically insulating, ceramic coating.

Such ceramic separators are usually cut to the desired shape using customary commercially available cutting utensils, such as round knives, shears, crocodile shears, etc., having blades of conventional or hardened knife steel. A disadvantage often incurred due to the use of conventional cutting tools is an enormous loss in material due to abrasion during the cutting and/or punching. Furthermore, conventional commercial blades are rapidly blunted during this use, probably due to abrasion. Inter alia, irregular cutting patterns may also result.

Ceramic separators to be employed in lithium ion batteries, may be supplied in the form of rolls which are cut to the dimensions required for the lithium battery. The cutting and/or punching of the separators can be effected with conventional cutting tools, such as, for example, shears, knives, punch, etc. Generally, steel, e.g. stainless steels, Swedish steel or powder metallurgical high-speed steel, is used for the production of these conventional tools. However, the cutting and/or punching of the ceramic separators using conventional steel-based tools often leads to abraded metal particles on the tools, which then remain adhered to the separators as a contaminant. Such contaminated ceramic separators lead to undesired effects when incorporated in lithium ion batteries. For example, the abraded metal particles adhered to the separator can result in electrical short circuits in the battery. Short circuiting may also be caused by damage to the separators if, owing to the dimensions of the abraded particles, these particles are forced through or pressed through the separator.

### BRIEF DESCRIPTION OF THE DRAWINGS

FIG. 1 shows a ceramic separator cut with a conventional stainless steel knife.

FIG. 2 shows a ceramic separator cut with a knife according to the present invention.

### DETAILED DESCRIPTION OF THE PREFERRED EMBODIMENTS

An object of the present invention is to provide a method for cutting to size and/or punching an abrasive material, to obtain a clean cut edge after the cutting and/or punching, which has no abrasion and therefore no contamination of the cut material, in particular, no metallic abraded particles which could lead to short circuits during use of the cut material in batteries. Another object of the present invention is to provide a cutting tool for the inventive method which has a long service life and suffers minimal blunting.

This object may surprisingly be achieved by a method for cutting and/or punching a material comprising a substrate and abrasive particles, the abrasive particles being present within and/or on at least a part of the surface of the substrate, where the method employs a cutting tool coated with a ceramic material or a cutting tool consisting of a ceramic material or a cutting tool comprising a ceramic material.

The method according to the invention for cutting and/or punching a material composed of a substrate and abrasive particles provides substantial improvement as indicated by reduced abrasion and/or reduced adhered metal particles compared with conventional cutting methods. This may be evident in particular, in the case of separator materials having ceramic fillings or coatings, such as SEPARION® from EVONIK, but also other sheet-like, optionally rolled-up ceramic materials which have to be cut to size. SEPARION® is a ceramic-polymeric composite film, the ceramic particles comprising Al₂O₃ and SiO₂ being applied in and on a polymer nonwoven, for use as a separator for lithium ion batteries. Other abrasive materials, such as, abrasive paper, may also be cut or punched with the described significant improvement according to the claimed method using the claimed cutting or punching tools. The advantages obtained according to the invention may include an improved, i.e. cleaner cutting pattern, reduced abrasion, substantially longer service lives of the blades used, without blade abrasion or blunting of the cutting edge, less contamination both of the cutting machine and of the cut material and avoidance of metallic abrasion which may lead to short circuits during use of the material in the battery.

Within the context of the present invention, all ranges mentioned herein explicitly contain all subvalues between the lower and upper limits.

According to one embodiment of the invention, the material to be cut and/or to be punched may comprise, for example, a substrate which consists of plastic, of porous plastic, of a nonwoven or woven fabric of such plastics, of paper or board or which comprises at least one of these materials. The material to be cut and/or to be punched may, however, also comprise a laminate as a substrate, the laminate comprising at least one of the abovementioned materials. However, the substrate may also be, for example, a laminate which consists of at least two of these materials.

The substrate may be polymer nonwovens of plastics fibres of polyethylene (PE), polypropylene (PP), polyacrylate, polyamide (PA; PA nonwoven, Freudenberg), polyacrylonitrile, polyester (PET) or polycarbonate (PC), or mixtures thereof. The membranes may have polymer nonwovens which are flexible and preferably may have a thickness of less than 100 μm, more preferably less than 50 μm, even more preferably less than 30 μm and most preferably 10 to 20 μm. In addition the substrate may have a polymer nonwoven having a weight per unit area of less than 50 g/m², preferably a nonwoven which has a weight per unit area of less than 30 g/m², more preferably less than 20 g/m², and most preferably from 5 to 15 g/m².

In order to be able to achieve a sufficiently high efficiency of the batteries, in particular in the case of lithium ion batteries, it may be advantageous if the substrate has a porosity preferably greater than 50%, preferably of 50 to 97%, particularly preferably of 60 to 90% and very particularly preferably of 70 to 90%. The porosity P may be defined as the volume of the nonwoven (V_{nonwoven}) minus the volume of the fibres of the nonwoven (V_{fibers}), where V_{nonwoven} minus V_{fibers}=V_{cavity}, divided by the total volume V_{nonwoven}. Hence, P=(V_{nonwoven}−V_{fibers})/V_{nonwoven}. The volume of the nonwoven may be calculated from the dimensions of the nonwoven. The volume of the fibers is obtained from the measured weight of the nonwoven considered and the density of the polymer fibers.

A pore radius distribution which is as homogeneous as possible in the nonwoven substrate may be important for use as a separator substrate. A pore radius distribution which is as homogeneous as possible in the nonwoven substrate, in combination with optimally matched oxide particles of a certain size, may lead to an optimized porosity of the membrane according to the invention, in particular with a view to the use as a separator. Accordingly, the membrane according to the invention preferably has a nonwoven which has a pore radius distribution in which at least 50% of the pores have a pore radius of 100 to 500 μm, more preferably in which at least 60% of the pores have a pore radius of 100 to 500 μm and most preferably, in which at least 70% of the pores have a pore radius of 100 to 500 μm.

As polymer fibers, the nonwoven substrate preferably has electrically nonconductive fibres of polymers, which are preferably selected from polyacrylonitrile (PAN), polyester, such as, for example, polyethylene terephthalate (PET), polyamide (PA), such as, for example, polyamide 12 or polyolefins, such as, for example, polypropylene (PP) or polyethylene (PE). The nonwoven particularly preferably has polymer fibers comprising polyester, in particular PET, and/or polyamide, in particular polyamide 12, or consists completely of these polymer fibres. The polymer fibers of the nonwovens preferably may have a diameter of 0.1 to 10 μm, particularly preferably of 1 to 5 μm.

The membranes/separators to be processed preferably have a thickness of less than 100 μm, preferably less than 50 μm, and most preferably a thickness of 5 to 35 μm. The thickness of the separator has a considerable influence on the properties of the separator since firstly the flexibility but also the surface resistance of the separator impregnated with electrolyte is dependent on the thickness of the separator. A particularly low electrical resistance of the separator in the application with an electrolyte may be achieved by a small thickness. The separator itself does of course may have a very high electrical resistance since it must itself have insulating properties. Moreover, thinner separators permit a higher packing density in a battery stack, so that a greater quantity of energy can be stored in the same volume. Conventional cutting or punching tools are not suitable for obtaining cuts which are regular in a microscopic range during cutting or punching of such thin particle-containing material. Reproducible cuts which are regular in a microscopic range and a long service life of the blade material may be obtained according to the method and tools of the claimed invention.

The substrates according to the claimed method may also be porous plastics films, on which a ceramic layer is applied on one or both sides so that a similar composite material having the properties described above may be obtained. Woven plastic fabrics may also be processed analogously to a plastics nonwoven. WO 02/15299 and WO 02/071509 describe a method for the production of separators based on polymer-ceramic composites.

Alternatively—for example for maintaining higher safety standards in batteries—flexible ceramic separators may be used. Flexible separators are described, for example, in DE 102 08 277, DE 103 47 569, DE 103 47 566 or DE 103 47 567.

In addition, DE 199 18 856 A1 describes separators which consist of a heat-resistant aromatic polymer and a ceramic powder, which are applied in a coating process to a substrate comprising a woven fabric, nonwoven, paper or a porous sheet. These separators may contain a thermoplastic resin which melts on excessive heating of the cell and thereby closes the cavities of the separating element. The content of the ceramic powder may be up to 95% by weight, based on the total weight of the separator.

In a preferred embodiment of the method according to the invention, the substrate is a plastic or contains a plastic and at least a part of the abrasive particles is enclosed in the matrix formed by the plastic. Alternatively, the substrate may be a porous plastic or may contain a porous plastic, and at least a part of the abrasive particles may be present at least partly in the pores of the plastic. The abrasive particles may additionally or exclusively be present on at least a part of the surface of the substrate.

A dispersion which has a proportion of ceramic particles, based on the total dispersion, of 10 to 60% by mass, preferably of 15 to 40% and particularly preferably of 20 to 30% by mass, may preferably be used for the production of a typical SEPARION representative. With regard to the binder, a dispersion which has a proportion of organic binder of 0.5 to 20% by mass, preferably of 1 to 10% by mass and particularly preferably of 1 to 5% by mass may be used. The end product may have a proportion of ceramic of 20 to 90% by mass, preferably 30-80% by mass and most preferably, 40-70% by mass, and may be solvent-free and anhydrous.

In the context of the present invention, “abrasive particles” may be understood as meaning material which has a greater hardness than the complementary material. The abrasiveness may be predicted on the basis of the Mohs' hardness. Such abrasive particles may have, for example, oxidic or ceramic particles having a hardness of up to 9 Mohs. This corresponds to corundum, i.e. alumina. In a preferred embodiment of the invention, the abrasive particles are therefore oxidic or ceramic particles and have a Mohs' hardness of at least 7, preferably at least 8, particularly preferably at least 9.

In mineralogy, the scratch hardness according to Mohs (Mohs' hardness) may be used for the qualitative classification and for the determination of the minerals. It is understood as meaning the resistance which a mineral offers to the penetration of a knife or of another mineral which is passed with strong pressure over a fresh, unweathered fracture, cleavage or crystal surface (cf. cleavability). Thus, the Mohs' hardness of a mineral B is between that of mineral A by which it is scratched and that of mineral C which it itself scratches. For the value of the Mohs' hardness, M_{hA}>M_{hB}>M_{hC} is then true. The Mohs' hardness is a dimensionless relative comparative value without a physical background between Mohs' degrees of hardness 1 (talc) and 10 (diamond). Table 1 lists representative Mohs' values.

TABLE 1

| Hardness level | Reference mineral |
|---|---|
| 1 | Talc |
| 2 | Gypsum, rock salt (fingernail) |
| 3 | Calcite (copper) |
| 4 | Fluorite (pure iron) |
| 5 | Apatite (cobalt) |
| 6 | Orthoclase (silicon, tantalum) |
| 7 | Quartz (tungsten) |
| 8 | Topaz (chromium, hardened steel) |
| 9 | Corundum, sapphire |
| 10 | Diamond |

Table 1 shows that metals have a lower hardness (≦7), i.e. can be scratched by separator material such as corundum, sapphire and diamond. This difference in Mohs' hardness may be used to explain the abrasion and short service life of a conventional metal knife. Applicants have determined on the basis of the claimed invention that the advantages of the claimed invention are obtained when the hardness of the blade is greater than or at least the same as the hardness of the material of the abrasive oxidic and/or ceramic particles.

The following may be mentioned by way of example as oxidic and/or ceramic particles: alumina (Al₂O₃), zirconia (ZrO₂), rutile (TiO₂), quartz (SiO₂), barium titanate (BaTiO₃), magnesium oxide (MgO), indium tin oxide (ITO) or mixtures of these materials or mixtures which contain these materials. Other non-oxidic or non-ceramic abrasive particles (for example cleaning bodies) may be: Si₃N₄, calcium carbonate (CaCO₃), aluminium hydroxide (Al(OH)₃), apatite (Ca₅(PO₄)₃X), metals (W).

In a particularly preferred embodiment of the method according to the invention, the material to be cut or to be punched may be a ceramic separator material which is preferably intended for use in electrochemical applications, for example, (super)capacitors, batteries, lithium ion batteries or lithium metal batteries.

In the context of the present invention, “ceramic separators” are understood as meaning customary separators which are used in electrochemical applications and which are coated with “abrasive particles” as defined above or contain such particles. Examples of such electrochemical applications are capacitors, supercapacitors, batteries, lithium ion batteries and lithium metal batteries.

In an embodiment of the method according to the invention, the cutting or punching tool used for cutting and/or punching may be a cutting or punching tool coated with a ceramic material. In this case, the surface or a part of the surface of the cutting or punching tool may be coated with one or more layers which consist of titanium carbide (TiC), titanium nitride (TiN), titanium carbonitride (TiCN), zirconium carbide (ZrC), zirconium nitride (ZrN), zirconium carbonitride (ZrCN), titanium aluminium nitride (TiAlN), alumina (Al₂O₃), zirconia (ZrO₂), titanium oxide (TiO₂), chromium nitride (CrN), silicon carbide (SiC), tungsten carbide (WC), titanium boride (TiB₂) or polycrystalline cubic boron nitride (cBN) or predominantly contain these materials. The coating(s) may also be metal-containing (metal=Ti, Cr, WC, and the like) amorphous carbon or may predominantly contain these materials. In the case of a plurality of layers lying one on top of the other, the layers may each contain or partly contain another of the abovementioned materials.

In the above cases where the layer or the layers may be TiC, TiN, TiCN, ZrC, ZrN, ZrCN, TiAlN, Al₂O₃, ZrO₂, TiO₂, metal-containing molybdenum disulphide or metal-containing amorphous carbon or may contain these materials, the respective layer or layers may be applied by a CVD, PVD or PACVD method.

In a PVD method, the coating material, for example a metal, such as titanium, zirconium or aluminium, an oxide such as silica or a salt is heated by a vapour deposition (vaporization) method in a high vacuum up to the transition from the solid via the liquid to the gaseous state. The required heating is effected by bombardment with high-energy electrons, by lasers or by electrical resistance heaters and, depending on the layer material (for example TiAlN), also a gas (N₂, Ar). In addition to these heating techniques, an arc vaporization method in which the electrode material is vaporized by igniting an arc between two electrodes may also be used.

In contrast to the PVD methods, chemical processes take place in CVD methods. According to a CVD method, the component to be deposited may be produced from starting materials (precursors) during the process itself and is deposited from the gas-phase. The temperature of a CVD method may be from 200 to 2000° C. and the temperature may be obtained by thermal activation, plasma-activation, photon-activation or laser-activation. The individual gas components may be passed with a carrier gas at pressures from 1 to 100 kPa through a reaction chamber in which the chemical reaction takes place and the resulting solid-state components are deposited as a thin layer, e.g. 2 TiCl4+2 NH3+H2→2 TiN+8 HCl. The volatile by-products may be removed with the carrier gas. By means of chemical gas-phase deposition, it may be possible to coat substrates (provided that they are stable at the temperatures) with numerous metals, semiconductors, carbides, nitrides, borides, silicides and oxides. Among the uses are the production of hard-wearing layers comprising, for example, titanium nitride, titanium carbide, ditungsten carbide, or corrosion protection layers, for example comprising niobium carbide, boron nitride, titanium boride, alumina, tantalum and silicides. The layers usually reach thicknesses of 0.1 to 1 μm.

Crystalline diamond layers may be deposited from a process gas comprising 1% of methane and 99% of hydrogen in vacuo and at high temperatures. The layers likewise reach thicknesses of 0.1 to 1 μm.

Important examples of these layers include:

Titanium aluminium nitride (TiAlN):

Hardness: about 3300 HV

Oxidation from: up to 800° C.

Layer thickness: up to a few μm

Coating temperature: from 180 to 450° C.

As a result of the action of temperature during use, aluminium oxide forms on the surface. This leads to outstanding heat removal and extremely great hardness of the material.

Titanium carbonitride (TiCN):

Hardness: about 3000 HV

Oxidation from: 400° C.

Layer thickness: up to a few μm

Coating temperature:

from 300 to 450° C.

This material has very high hardness.

In the above examples, hardness is described according to the Vickers hardness. A relation of Vickers hardness to Mohs hardness is shown in Table 2.

TABLE 2

| | Hardness | Vickers | |
|---|---|---|---|
| Mineral | (Mohs) | hardness in HV | Remarks |
| Talc | 1 | 2.4 | scrapable with the |
| | | | fingernail |
| Gypsum | 2 | 36 | scratchable with the |
| or halite | | | fingernail |
| Calcite | 3 | 109 | scratchable with copper |
| | | | coin |
| Fluorite | 4 | 189 | easily scratchable with a |
| | | | knife |
| Apatite or | 5 | 536 | still scratchable with a |
| manganese | | | knife |
| Orthoclase | 6 | 795 | scratchable with steel file |
| Quartz | 7 | 1120 | scratches window glass |
| Topas | 8 | 1427 | |
| Corundum | 9 | 2060 | |
| Diamond | 10 | 10060 | hardest naturally occurring |
| | | | mineral |

A flame-spraying method may be employed to apply a layer of or containing TiC, TiN, TiCN, ZrC, ZrN, ZrCN, TiAlN, Al₂O₃, ZrO₂, TiO₂, metal-containing molybdenum disulfide or metal-containing amorphous carbon.

In the flame-spraying method, i.e. the manufacturing method for surface treatment of (metallic) workpieces, the metallic surface of the blade may be covered at high temperatures with a material which has a high hardness. This may be the abovementioned materials. For this purpose, the pulverulent or wire-like spray additive is melted in a combustion gas-oxygen flame (or flame containing other gases) and sprayed by the combustion gas alone or with the aid of an atomizer gas onto the suitably prepared workpiece surface. The molten spray particles solidify, adhere to the workpiece surface and form a cohesive coating there. In addition to ceramic materials, metallic coatings can also be produced in this way. References descriptive of this method include DIN 8522: 1980-09, Production processes of autogenous engineering, overview; DIN EN 657: 2005-06, Thermal spraying—definitions, classifications; Römpp Chemie Lexikon Online, Thieme Verlag.

The flame-spray method permits the coating of very different, optionally individually prepared surfaces, as well as surfaces having varying geometries. Accordingly, successful coating of all blade, knife or cutting edge forms may be possible. The resulting layer thicknesses of the finished tools are—in contrast to the layers obtained in PVD/CVD methods—in the two-digit μm range up to a few millimetres. By suitable choice of the described methods, the range of layer thickness possible to obtain may be extended and thus the usability of the working materials obtained (blades and cutting edges or punches) may also be extended. Thus, with these thicker layers, it may be possible to apply a softer layer to the tool or blade which firstly has a lower friction resistance and secondly has lower abrasion on the material to be cut or to be punched but which is safe owing to its ceramic character. Due to the layer thickness, the service life of the tool may also be extended in comparison to conventional tools.

For the application according to the invention, coatings obtained in the flame-spraying method may be reworked in an additional operation, i.e. ground and polished, in order to eliminate surface irregularities that may form during the coating process.

The coating(s) may be or contain diamond or a diamond-like material, for example, carbon (C) or cubic boron nitride (BN).

A nanocrystalline diamond coating may be obtained by chemical gas-phase deposition (Chemical Vapour Deposition—CVD). The diamond coating may be applied by a hot-filament CVD (HFCVD) method, which is a typical thermal CVD method known to one of ordinary skill in the art. This is a customary method for the surface treatment of materials. Nanocrystalline and/or microcrystalline diamond layers may be obtained by a HFCVD method. The layers of nanocrystalline and/or microcrystalline diamond may be complicated to produce, may have poor adhesion to the substrate and therefore may be very expensive but are the most hard-wearing in combination with having an extremely low coefficient of friction. Diamond layers may also be applied to the substrates by PVD or Pulsed Laser Deposition (PLD).

In the abovementioned cases, the coated cutting tool itself preferably may be a steel, e.g. 1.4034 knife steel.

The steels to be used as substrates should have as high a tempering temperature as possible. This is the temperature at which embrittlement phenomena from a preceding hardening step or another heat treatment are completely or partly eliminated. This elimination is undesired in the case of hard knife steel and also for a PVD or CVD after treatment, so that it may be consequently advantageous to work with the steels below this temperature. Thus, the higher the tempering temperature of a steel, the higher the temperatures to which the steel may be exposed during use without it losing its hardening structure.

Conventionally used steels include: German knife steel is X46Cr13 (material number 1.4034, American designation AISI 420 C). According to the material designation, it is highly alloyed and contains 0.46% of carbon and 13% of chromium. As a ferrite former, chromium firstly ensures the resilience and the hardness and secondly counteracts oxidation (freedom from rust).

A steel specially developed for knife blades is the powder metallurgical steel CPM S30V from Crucible Materials Corp., Syracuse USA. This steel contains 1.45% of carbon, 14% of chromium, 4% of vanadium and 2% of molybdenum.

Furthermore, nonrusting steels exemplified by the steels listed in Table 3 may be used:

TABLE 3

| EN | |
|---|---|
| standard | EN standard |
| Material No. | Short name |
| 1.4016 | X6Cr17 |
| 1.4509 | X2CrTiNb18 |
| 1.4510 | X3CrTi17 |
| 1.4512 | X2CrTi12 (formerly X6 CrTi 12) |
| 1.4526 | X6CrMoNb17-1 |
| 1.4310 | X10CrNi18-8 (formerly X12 |
| | CrNi17 7) |
| 1.4318 | X2CrNiN18-7 |
| 1.4307 | X2CrNi18-9 |
| 1.4306 | X2CrNi19-11 |
| 1.4311 | X2CrNiN18-10 |
| 1.4301 | X5CrNi18-10 |
| 1.4948 | X6CrNi18-11 |
| 1.4303 | X4CrNi18-12 (formerly X5 CrNi18 |
| | 12) |
| 1.4541 | X6CrNiTi18-10 |
| 1.4878 | X10CrNiTi18-10 (formerly X12 |
| | CrNiTi18 9) |
| 1.4404 | X2CrNiMo17-12-2 |
| 1.4401 | X5CrNiMo17-12-2 |
| 1.4406 | X2CrNiMoN17-11-2 |
| 1.4432 | X2CrNiMo17-12-3 |
| 1.4435 | X2CrNiMo18-14-3 |
| 1.4436 | X3CrNiMo17-13-3 |
| 1.4571 | X6CrNiMoTi17-12-2 |
| 1.4429 | X2CrNiMoN17-13-3 |
| 1.4438 | X2CrNiMo18-15-4 |
| 1.4539 | X1NiCrMoCu25-20-5 |
| 1.4547 | X1CrNiMoCuN20-18-7 |

In another embodiment of the method according to the invention, the cutting or punching tool used for cutting and/or punching may at least predominantly contain a ceramic material (C, abbreviations according to ISO 513) or polycrystalline cubic boron nitride (BN). The cutting or punching tools consisting of a ceramic material may be described as cutting ceramics. For this purpose, the ceramic blanks may be ground into the desired shape. The ceramic blades thus obtained may then be used in the same manner as the steel-based blades. The polycrystalline cubic boron nitride may be applied as a layer by high-pressure liquid-phase sintering to hard metal plates or may be produced as a solid body. When applied as a layer titanium nitride or titanium carbide may be employed as a binding phase.

The cutting ceramics which may be used according to the invention may be oxidic ceramics (CA), non-oxide ceramics (CN), mixed ceramics (CM) and whisker-reinforced ceramics (CR). Oxidic ceramics may include, for example, alumina (Al₂O₃), zirconia (ZrO₂) or titanium oxide (TiO₂). Oxidic mixed ceramics, for example those based on alumina, which contain up to 20% of dispersed zirconia (ZrO₂), may also be particularly suitable according to the claimed invention. Among the non-oxide ceramics, in particular a ceramic comprising silicon nitride (Si₃N₄) is suitable. The likewise suitable mixed ceramics may be sintered from, for example, alumina and hard materials, such as titanium carbide, tungsten carbide or titanium nitride. Whisker-reinforced cutting ceramics are ceramic composite materials reinforced with silicon whiskers and based on alumina.

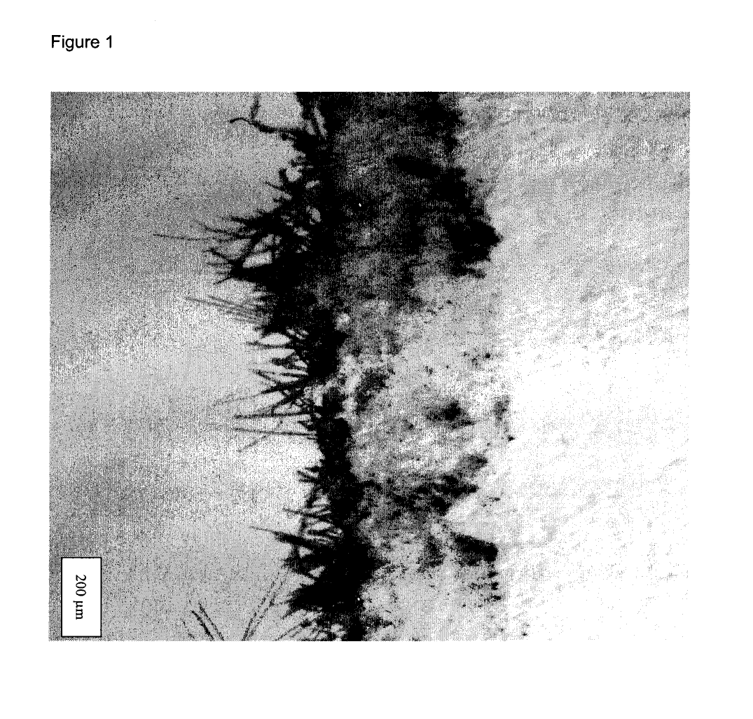

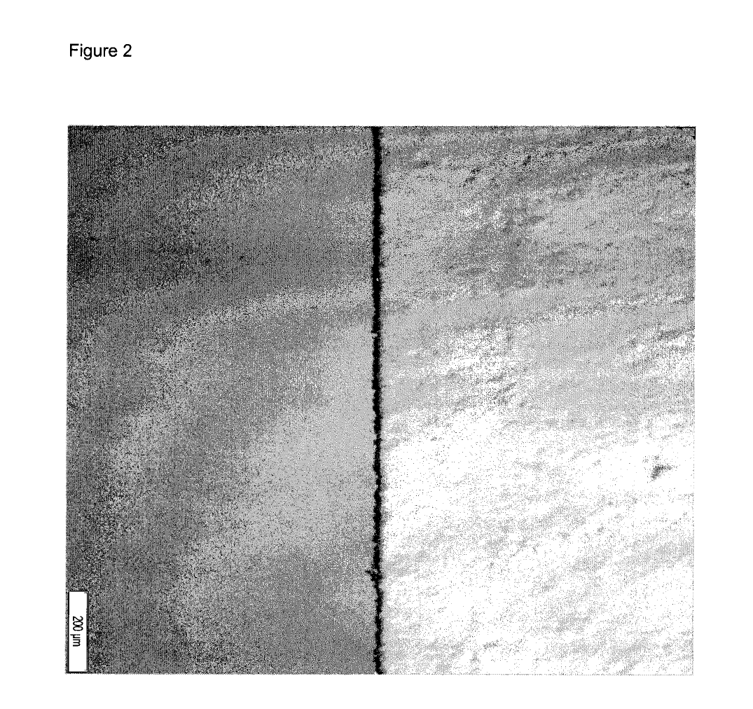

FIG. 1 shows an approximately 50 μm thick ceramic separator which was cut with a conventional stainless steel-based knife. The stainless steel-based knife leads to clearly recognizable metal abrasion. The scale in FIG. 1 corresponds to the scale reproduced in FIG. 2.

FIG. 2 shows an approximately 50 μm thick ceramic separator which was cut according to the method of the claimed invention employing shears having ceramic blades. Metal abrasion is virtually undetectable. Analogous results are obtained with a power guillotine having ceramic blades or ceramic-coated knives.

Having generally described this invention, a further understanding can be obtained by reference to certain specific examples which are provided herein for purposes of illustration only, and are not intended to be limiting unless otherwise specified.

### EXAMPLES

FIGS. 1 and 2 show, by way of example, the cutting results with standard cutting edges (steel, untreated; FIG. 1) and optimized cutting edges (hardened or covered with ceramics; FIG. 2).

### Example 1

For cutting small quantities (individual sheets) of ceramic-containing membranes, the cutting edges of crocodile shears from Dahle (type 00561); lever cutting machine with stable metal table screwed surface-ground upper knife and ground lower knife comprising Solinger knife steel) were equipped with a hard surface. After dismantling and cleaning of the upper and lower knives, the surface was provided with titanium aluminium nitride (TiAlN) in a PVD method. Thickness about 5 μm.

On cutting of approx. 50 μm thick SEPARION® films, it was possible to obtain a very clean cutting pattern without metal abrasion (comparable with that in FIG. 2). As a result of the coating, the service life (definition: duration up to next required grinding if the cut quality has substantially deteriorated owing to tears or furrows in the cut material) could be improved by more than a factor of five. Regrinding was not necessary beforehand.

### Example 2

For cutting stacked layers of SEPARION® (about 100 pieces of about 50 μm thickness in widths up to 250 mm), a power guillotine from IDEAL (model 6550) was used. The knives supplied were likewise subjected to cleaning and then coated with TiCN in a thickness of 1 μm in a PVD method. If the abovementioned stacks of SEPARION® are cut with this setup, discolorations of the cut edges are not found in the case of any cut. This could also be confirmed from REM-EDX analyses, in which no impurities could be identified.

### Example 3

A SEPARION® ceramic film was cut to the desired size using ceramic shears manufactured by Kyocera. With this tool, the material could be cut cleanly and without residue. A regular cutting pattern without metal abrasion comparable with that shown in FIG. 2 was obtained.

### Example 4

Circular pieces of the ceramic film were punched out with a circular hollow punch having a diameter of 4 cm. With this tool, the material was cut cleanly and without residue. A clean edge without metal abrasion comparable with that shown in FIG. 2 was obtained.

### Comparative Example 1 (to Example 2)

For cutting stacked layers of SEPARION® (about 100 pieces of about 50 μm thickness in widths up to 250 mm), a power guillotine from IDEAL (model 6550) was used. If such SEPARION® stacks are cut using the blade supplied, a considerable amount of abraded particles from the blade was found on the cut edge in the first cut. This manifests itself by soiling of the cut edge (grey discoloration).

### Comparative Example 2 (to Example 3)

As a simple experiment for illustrating the abrasiveness in the ceramic SEPARION® film, the latter was cut using commercially available office scissors (hardened blade steel) in individual layers. The cut edges were irregular and frayed and abrasion in the form of grey-black particles comparable with the cut edge shown in FIG. 1 is found at and on the cut edge.

Numerous modifications and variations on the present invention are possible in light of the above teachings. It is therefore understood that within the scope of the appended claims, the invention can be practiced otherwise than as specifically described herein.

1. A method for cutting and/or punching a material, comprising:
cutting or punching the material with a cutting or punching tool;
wherein
the material being cut or punched comprises a substrate comprising abrasive particles,
wherein
the abrasive particles are present with the substrate in at least one position selected from the group consisting of
on at least a part of a surface of the substrate,
within the substrate, and
both on at least a part of a surface of and within the substrate,
the cutting or punching tool is:
a cutting or punching tool coated with a ceramic material;
a cutting or punching tool consisting of a ceramic material; or
a cutting or punching tool comprising a ceramic material.

2. The method according to claim 1, wherein the substrate is selected from the group of substrates consisting of:
a substrate consisting of a plastic, a porous plastic, a nonwoven plastic fabric, a woven plastic fabric, a paper, and a board;
a substrate comprising at least one of a plastic, a porous plastic, a nonwoven plastic fabric, a woven plastic fabric, a paper, or a board;
a laminate substrate comprising at least one of a plastic, a porous plastic, a nonwoven plastic fabric, a woven plastic fabric, a paper, or a board; and
a laminate consisting of at least two of a plastic, a porous plastic, a nonwoven plastic fabric, a woven plastic fabric, a paper, or a board.

3. The method according to claim 2, wherein
the substrate consists of a plastic and at least a part of the abrasive particles is enclosed in a matrix formed by the plastic, or
the substrate comprises a plastic and at least a part of the abrasive particles is enclosed in a matrix formed by the plastic.

4. The method according to claim 2, wherein
the substrate consists of a porous plastic and at least a part of the abrasive particles is present in pores of the porous plastic, or
the substrate comprises a porous plastic and at least a part of the abrasive particles is present in pores of the porous plastic.

5. The method according to claim 1, wherein
the abrasive particles are at least one of oxidic or ceramic particles, and
a Mohs' hardness of the abrasive oxidic or ceramic particles is at least 7.

6. The method according to claim 1, wherein the material to be cut and/or punched is a ceramic separator material for an electrochemical application selected from the group of electrochemical applications consisting of a capacitor, a supercapacitor, a battery, a lithium ion battery and a lithium metal battery.

7. The method according to claim 1, wherein the cutting or punching tool is coated with one or more layers each of which, independently of one another, comprises a material selected from the group consisting of TiC, TiN, TiCN, ZrC, ZrN, ZrCN, TiAlN, Al₂O₃, ZrO₂, TiO₂, CrN, SiC, WC, TiB₂, cBN and a metal-containing amorphous carbon.

8. The method according to claim 1, wherein the cutting or punching tool is coated with one or more layers each of which, independently of one another, consists of a material selected from the group consisting of TiC, TiN, TiCN, ZrC, ZrN, ZrCN, TiAlN, Al₂O₃, ZrO₂, TiO₂, CrN, SiC, WC, TiB₂, cBN and a metal-containing amorphous carbon.

9. The method according to claim 7, wherein the one or more layers are applied by a CVD, PVD or PACVD method.

10. The method according to claim 8, wherein the one or more layers are applied by a CVD, PVD or PACVD method.

11. The method according to claim 7, wherein the one or more layers are applied by a flame-spraying method.

12. The method according to claim 8, wherein the one or more layers are applied by a flame-spraying method.

13. The method according to claim 1, wherein the cutting or punching tool is coated with one or more layers which independently consist of diamond or a diamond-like material.

14. The method according to claim 1, wherein the cutting or punching tool consists of polycrystalline cubic boron nitride (BN) or a cutting ceramic (C).

15. The method according to claim 14, wherein the cutting ceramic is a ceramic selected from the group consisting of an oxidic ceramic (CA), a nonoxide ceramic (CN), a mixed ceramic (CM) and a whisker-reinforced ceramic (CR).

16. The method according to claim 1, wherein the cutting or punching tool is selected from the group of tools consisting of a punch, a shear, a knife, a cutter, a crocodile shears, a power guillotine, a slitter rewinder and a longitudinal and cross cutter.

17. The method according to claim 16, wherein cutting edge(s) of the cutting or punching tool is a straight, curved or round cutting edge or punch.

18. The method according to claim 1, wherein more than one layer of the material is cut or punched.

19. The method according to claim 18, wherein the material to be cut or punched comprises stacked layers of the material to be cut or punched.

20. The method according to claim 7, wherein the cutting or punching tool is coated with titanium aluminium nitride (TiAlN).
